(19) United States
(12) Patent Application Publication
(10) Pub. No.: US 2012/0321124 A1
(43) Pub. Date: Dec. 20, 2012

(54) DIAPHRAGM AND MICRO-ELECTROACOUSTIC DEVICE INCORPORATING THE SAME

(75) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/598,642

(22) Filed: Aug. 30, 2012

Related U.S. Application Data
(63) Continuation-in-part of application No. 12/561,225, filed on Sep. 16, 2009, now Pat. No. 8,290,200.

(30) Foreign Application Priority Data
Jun. 8, 2009 (CN) 200910303056.3

(51) Int. Cl. H04R 1/00; H04R 7/00

(52) U.S. Cl. 381/423; 181/173

(57) ABSTRACT

An exemplary diaphragm includes a central portion and an external portion connecting the central portion. The central portion includes a central section in a center thereof, a peripheral section at an outer periphery thereof, and a connecting section interconnecting the central section and the peripheral section. The peripheral section forms two protrusions each having three recesses defined therein. A micro-electroacoustic device using the diaphragm is also provided.

### CROSS-REFERENCE TO RELATED APPLICATION

The present application is a continuation-in-part (CIP) application of patent application Ser. No. 12/561,225, entitled “DIAPHRAGM AND MICRO-ELECTROACOUSTIC DEVICE INCORPORATING THE SAME,” and filed on Sep. 16, 2009. The disclosure of the parent application is incorporated herein by reference in its entirety.

### BACKGROUND

1. Technical Field

The present invention relates generally to a micro-electroacoustic device, and more particularly to a diaphragm of a micro-electroacoustic device.

2. Description of Related Art

Sound is one important means by which people communicate with each other; thus, creating new methods for sound transference allows greater communication between people. Electroacoustic transducers are key components in transferring sound. A typical electroacoustic transducer has a magnetic circuit in which a magnetic field generated by a magnet passes through a diaphragm and returns to the magnet again. When an oscillating electric current is supplied to a coil fixed to the diaphragm and wound around the magnet, the corresponding oscillating magnetic field generated by the coil is then superimposed onto the magnetostatic field of the magnetic circuit. Thus, the diaphragm is driven to oscillate. The resulting oscillation of the diaphragm is then transmitted to the air as sound. Generally, a radial movement may occur during oscillation of the diaphragm. Such radial movement affects the quality of the produced sound. Therefore, a rigidity of the diaphragm needs to be increased for decreasing a radial movement during oscillation.

What is needed, therefore, is a diaphragm and a micro-electroacoustic device incorporating the diaphragm which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a micro-electroacoustic device in accordance with a first embodiment of the present disclosure.

FIG. 2 is a cross-sectional view of the micro-electroacoustic device of FIG. 1, taken along line II-II thereof.

FIG. 3 is a front, plan view of the micro-electroacoustic device of FIG. 1.

FIG. 4 is an exploded view of the micro-electroacoustic device of FIG. 1.

FIG. 5 is similar to FIG. 3, but showing a front, plan view of a micro-electroacoustic device in accordance with a second embodiment of the present disclosure.

FIG. 6 is a cross-sectional view of the micro-electroacoustic device of FIG. 5, taken along line VI-VI thereof.

### DETAILED DESCRIPTION

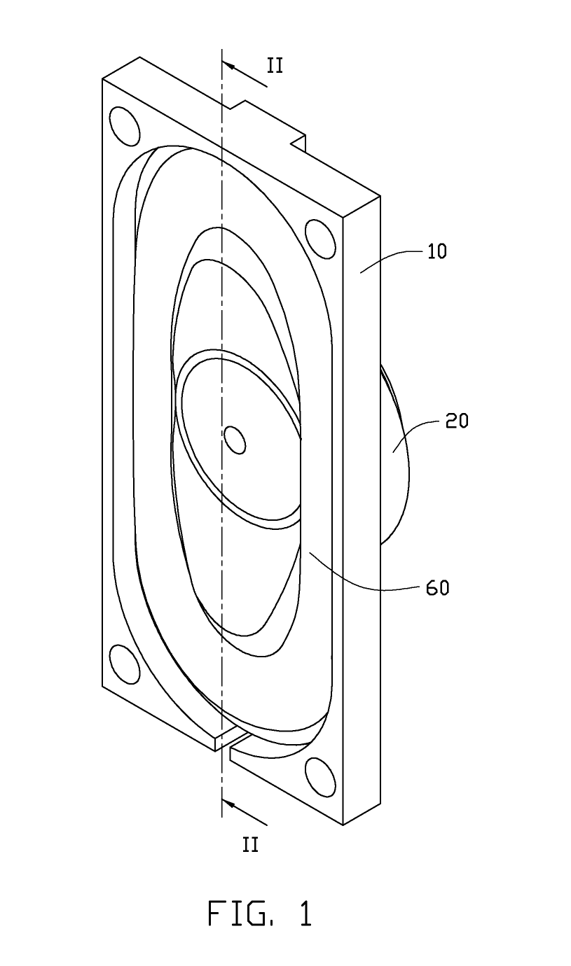

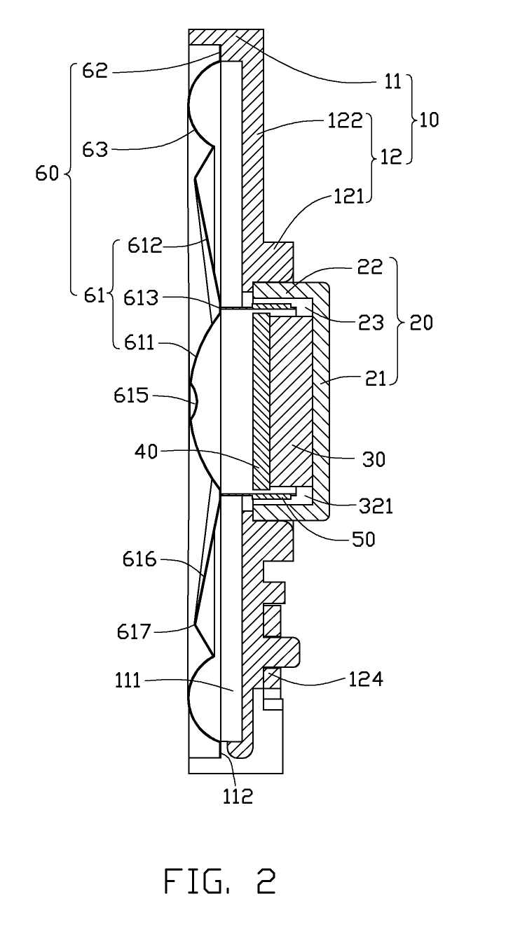

Referring to FIGS. 1-2, a micro-electroacoustic device in accordance with a first embodiment of the present disclosure is shown. The micro-electroacoustic device includes a housing 10, a cylindrical yoke 20 engaged with the housing 10, a disc-shaped magnet 30 disposed in the cylindrical yoke 20, a circular film-shaped washer 40 located on the magnet 30, a hollow cylinder-shaped coil 50 surrounding the magnet 30, and an elongated, film-shaped diaphragm 60 attached to the housing 10.

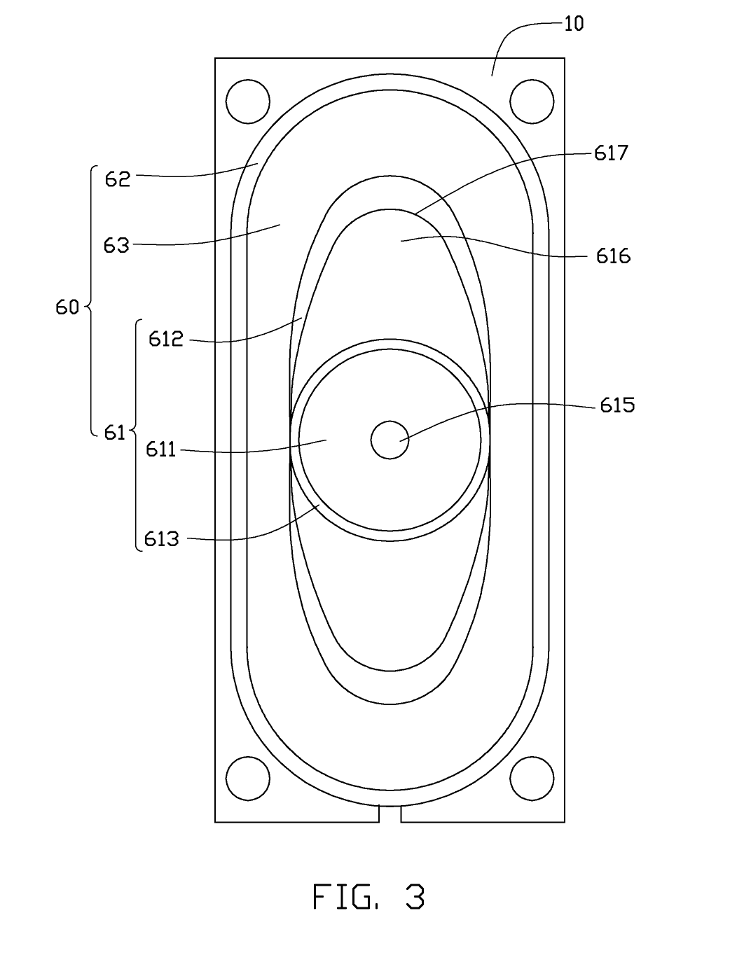

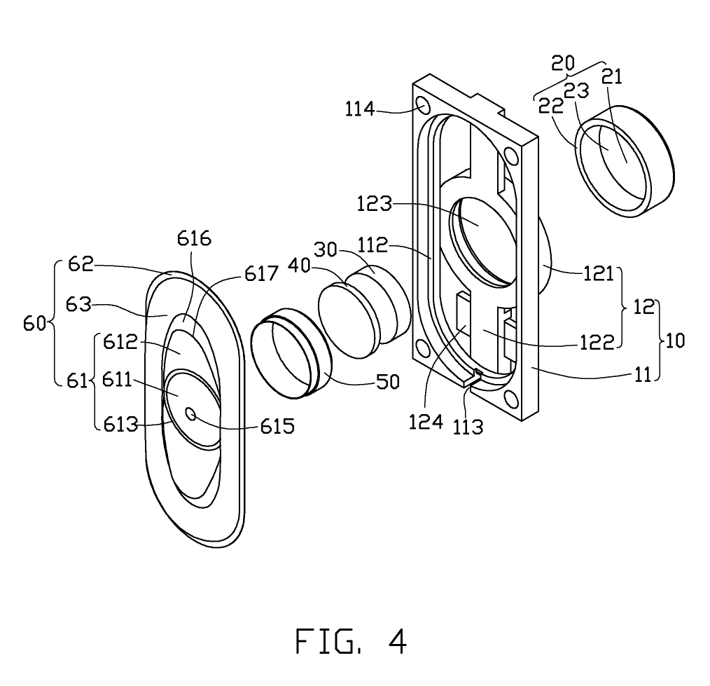

Referring also to FIGS. 3-4, the housing 10 includes a base plate 12 and a sidewall 11 extending from the base plate 12. The sidewall 11 defines a receiving chamber 111 therein. The receiving chamber 111 is elongated with arced top and bottom ends (see FIG. 4). An annular step 112 is formed on an inner peripheral surface of the sidewall 11. Each corner of the sidewall 11 defines a mounting hole 114 for mounting the micro-electroacoustic device onto an electronic device such as a mobile phone or a notebook computer (not shown). A groove 113 is defined in a bottom side of the sidewall 11 for receiving electrical lines (not shown) of the micro-electroacoustic device.

The base plate 12 is integrally formed with the sidewall 11 as a single monolithic piece. The base plate 12 includes a hollow cylinder-shaped seat 121, a top arm 122 connecting the seat 121 with a top side of the sidewall 11, and a bottom arm 122 opposite to the top arm 122 and connecting the seat 121 with the bottom side of the sidewall 11. A central axis of the seat 121 is coaxial with a central axis of the sidewall 11. Two opposite lateral sides of the seat 121 are attached to the sidewall 11. The seat 121 defines a through hole 123 therein. The top arm 122 extends upwardly from an outer peripheral surface of the seat 121 to the top side of the sidewall 11. The bottom arm 126 extends downwardly from the outer peripheral surface of the seat 121 to the bottom side of the sidewall 11. A printed circuit board 124 is attached to a rear surface of the bottom arm 122.

The cylindrical yoke 20 includes a circular base wall 21 and a side wall 22 extending frontward from an outer edge of the base wall 21. The cylindrical yoke 20 defines a receiving space 23 therein. The cylindrical yoke 20 is received in the through hole 123 of the seat 121. The through hole 123 of the seat 121 communicates with the receiving space 23 of the cylindrical yoke 20.

The magnet 30 and the washer 40 are coaxially received in the receiving space 23 of the cylindrical yoke 20. The magnet 30 is mounted on the base wall 21 of the cylindrical yoke 20. The washer 40 is mounted on the magnet 30. An inner diameter of the side wall 22 of the cylindrical yoke 20 is larger than an outer diameter of the magnet 30 and an outer diameter of the washer 40, whereby an inner peripheral surface of the side wall 22 of the cylindrical yoke 20, an outer peripheral surface of the magnet 30 and an outer peripheral surface of the washer 40 cooperatively define an annular magnetic gap 321 therebetween for accommodating the coil 50. The coil 50 surrounds the magnet 30 and the washer 40 and is movable in the annular magnetic gap 321.

The diaphragm 60 is elongated with arced top and bottom ends. The diaphragm 60 includes a central portion 61 in a central area thereof, an external portion 63 surrounding the central portion 61, and an annular flange 62 extending radially and outwardly from an outer peripheral edge of the external portion 63. The flange 62 of the diaphragm 60 is attached to the step 112 of the sidewall 11 for fixing the diaphragm 60 onto the housing 10.

The external portion 63 has a profile of a stadium track and has a semicircular-shaped cross section. The central portion 61 includes a dome-shaped central section 611 in a center of the central portion 61, a peripheral section 612 at an outer periphery of the central portion 61, and an annular connecting section 613 interconnecting the central section 611 and the peripheral section 612. The central section 611 defines a spherical depression 615 in a center thereof. Thus, the dome-shaped central section 611 and the spherical depression 615 of the central section 611 improve a rigidity of the diaphragm 60, thereby preventing the diaphragm 60 from abrupt and huge deformation during vibration at a center of the diaphragm 60. The connecting section 613 extends radially and outwardly from an outer edge of the central section 611. A front side of the coil 50 is attached to a rear surface of the connecting section 613 of the diaphragm 60.

The peripheral section 612 includes two protrusions 616 opposite to each other. Each protrusion 616 has a ridge 617 located at a frontmost position thereof. Each protrusion 616 has an inner face (not labeled) extending frontward and upwardly from the connecting section 613 to the ridge 617, and an outer face (not labeled) extending frontward and downwardly from the external portion 63 to the ridge 617. The inner face is larger than the outer face. The outer face of each protrusion 616 is more inclined than the inner face of each protrusion 616 relative to the connecting section 613. Thus, a low frequency characteristic of the micro-electroacoustic device is in harmony with a high frequency characteristic thereof.

The two protrusions 616 increase a rigidity of the diaphragm 60, thereby preventing the diaphragm 60 from abrupt deformation during vibration, and decreasing a radial vibration of the diaphragm 60 to improve a sound quality of the micro-electroacoustic device.

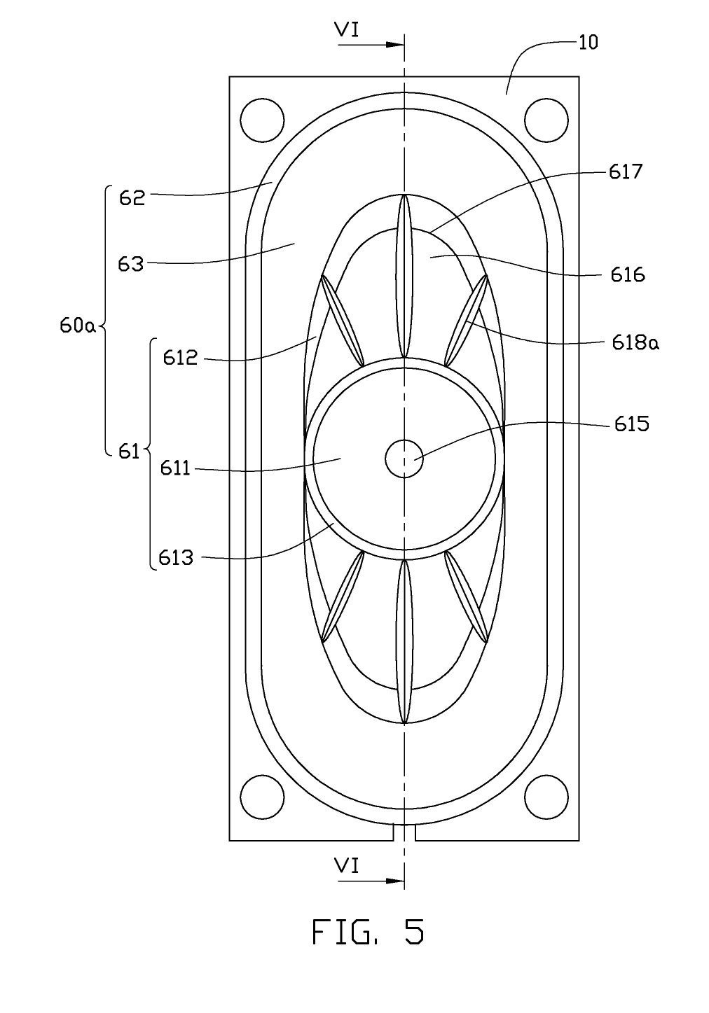

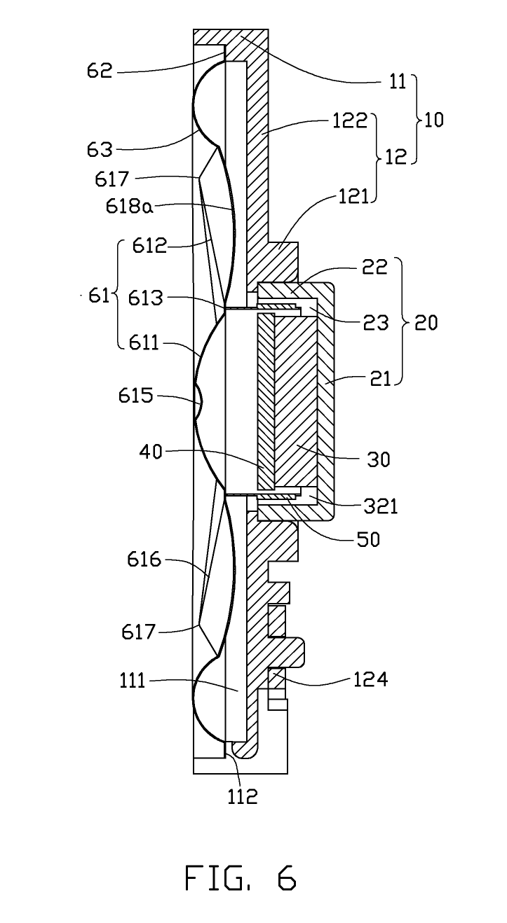

Alternatively, in addition to the protrusions 616, the diaphragm 60 can form more structures for further increasing the rigidity thereof. Referring to FIGS. 5-6, the diaphragm 60a has three recesses 618a defined in each protrusion 616 thereof. The three recesses 618a extend along radial directions of the diaphragm 60. Each recess 618a extends from an outer peripheral edge of the connection section 613 to an inner peripheral edge of the external portion 63 through a corresponding ridge 617. A middle one of the three recesses 618a has a width and a length larger than those of each of two lateral ones of the three recesses 618a. Each recess 618a has a width gradually increasing and then decreasing along a lengthwise direction thereof. A depth of each recess 618a is gradually increased and then decreased along the lengthwise direction of each recess 618a. The depth of each recess 618a is larger that that of the depression 615. Preferably, a deepest position of each recess 618a is located more rearward than the connection section 613. The deepest position of each recess 618a is deviated from the ridge 617 of a corresponding protrusion 616. That is, the deepest position of each recess 618a is not aligned with the ridge 617 of the corresponding protrusion 616. In this embodiment, the deepest position of each recess 618a is located nearer the connection section 613 than the ridge 617. The three recesses 618a can further decrease radial vibration of the diaphragm 60.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A diaphragm for an electroacoustic device, comprising:
a central portion in a center of the diaphragm, the central portion comprising a central section in a center of the central portion, a peripheral section at an outer periphery of the central portion, and a connecting section between the central section and the peripheral section, the peripheral section forming a protrusion with a recess defined in the protrusion; and
an external portion surrounding the central portion.

2. The diaphragm as claimed in claim 1, wherein the protrusion comprises a ridge protruding along a first direction, the recess extending through the ridge.

3. The diaphragm as claimed in claim 2, wherein the protrusion has an inner face extending from the connecting section to the ridge, and an outer face extending from the external portion to the ridge, the outer face being inclined relative to the inner face.

4. The diaphragm as claimed in claim 3, wherein the outer face of the protrusion is more inclined than the inner face of the protrusion relative to the connecting section.

5. The diaphragm as claimed in claim 2, wherein the recess has a deepest position deviated from the ridge.

6. The diaphragm as claimed in claim 2, wherein the central section has a depression concaved along a second direction opposite to the first direction, the depression having a depth less than that of the recess.

7. A micro-electroacoustic device comprising:
a housing;
a magnet received in the housing;
a coil surrounding the magnet; and
a diaphragm attached to the housing, the diaphragm comprising:
a central portion in a center of the diaphragm, the central portion comprising a central section in a center of the central portion, a peripheral section at an outer periphery of the central portion, and a connecting section between the central section and the peripheral section, the peripheral section forming a protrusion, the protrusion having a recess defined therein, and the coil being attached to a rear surface of the connecting section of the central portion; and
an external portion surrounding the central portion.

8. The micro-electroacoustic device as claimed in claim 7, wherein the protrusion comprises a ridge protruding frontward, the recess extending through the ridge.

9. The micro-electroacoustic device as claimed in claim 7, wherein the recess extends along a radial direction of the diaphragm.

10. The micro-electroacoustic device as claimed in claim 7, wherein the recess has a depth gradually increasing and then decreasing along a lengthwise direction thereof.

11. The micro-electroacoustic device as claimed in claim 7, wherein the recess has a width gradually increasing and then decreasing along a lengthwise direction thereof.

12. The micro-electroacoustic device as claimed in claim 8, wherein the recess has a deepest position deviated from the ridge.

13. The micro-electroacoustic device as claimed in claim 12, wherein the deepest position of the recess is located more rearward than the connecting section.

14. The micro-electroacoustic device as claimed in claim 8, wherein the protrusion has an inner face extending outwardly from the connecting section to the ridge, and an outer face extending inwardly from the external portion to the ridge.

15. The micro-electroacoustic device as claimed in claim 14, wherein the outer face is more inclined than the inner face relative to the connection section.

16. The micro-electroacoustic device as claimed in claim 14, wherein the outer face has an area less than that of the inner face.

17. The micro-electroacoustic device as claimed in claim 9, wherein the protrusion further defines another recess adjacent to the recess, the another recess extending along another radial direction of the diaphragm.

18. The micro-electroacoustic device as claimed in claim 17, wherein the another recess has a length and a width less than those of the recess.

19. The micro-electroacoustic device as claimed in claim 7, wherein the central section defines a depression in a center thereof, the depression having a depth less than that of the recess.

20. The micro-electroacoustic device as claimed in claim 7, wherein the diaphragm further comprises a flange connecting the external portion with the housing.
